(19) United States
(12) Patent Application Publication
(10) Pub. No.: US 2026/0091595 A1
(43) Pub. Date: Apr. 2, 2026

(54) PRINTING DEVICE

(71) Applicant: SEIKO EPSON CORPORATION, TOKYO (JP)

(72) Inventors: Takahiro SHIOZAKI, MATSUMOTO-SHI (JP); Hidekazu MORI, SHIOJIRI-SHI (JP); Yasumichi OKUDA, MATSUMOTO-SHI (JP); Sho SAKURAI, SHIOJIRI-SHI (JP); Yuki OKUBO, MATSUMOTO-SHI (JP)

(21) Appl. No.: 19/343,012

(22) Filed: Sep. 29, 2025

(30) Foreign Application Priority Data
Sep. 30, 2024 (JP) 2024-170141

(51) Int. Cl. B41J 3/46; B41J 11/66; B41J 11/70; B41J 29/46; H04N 1/00

(52) U.S. Cl. CPC B41J 3/46; B41J 11/663; B41J 11/70; B41J 29/46; H04N 1/00408; H04N 1/00488; H04N 1/0049

(57) ABSTRACT

A printing device includes: a printing unit that prints an image on a print medium; a cutter unit, a touch panel that accepts an operation of a cutting permission button for giving an instruction to cut the print medium; at least one of a touch panel, an indication lamp, and a speaker for giving a notification to outside, and a control unit that outputs a cutting instruction for the print medium to the cutter unit, and during a period from when the operation of the cutting permission button is accepted to when the cutting instruction is output, the control unit causes at least one of the touch panel, the indication lamp, and the speaker to notify a remaining time until the cutting instruction is output to the cutter unit, and the control unit outputs the cutting instruction to the cutter unit after the remaining time elapses.

The present application is based on, and claims priority from JP Application Serial Number 2024-170141, filed Sep. 30, 2024, the disclosure of which is hereby incorporated by reference herein in its entirety.

### BACKGROUND

### 1. Technical Field

The present disclosure relates to a printing device.

### 2. Related Art

In the related art, a printing device including a cutting mechanism that cuts a continuous print medium on which printing is finished is known. For example, JP-A-2016-198988 discloses an image forming device including a cutter that cuts a sheet.

JP-A-2016-198988 is an example of the related art.

However, when the print medium is cut by the cutting mechanism in a state where the ink is not sufficiently dried after printing, for example, the print medium may fall onto a floor surface or the like and the floor surface or the like may be stained with the ink.

### SUMMARY

According to an aspect of the present disclosure, a printing device includes: a printing unit configured to print an image based on print data, on a continuous medium; a cutting unit configured to execute a cutting operation, which is an operation of cutting the continuous medium on which the image is printed by the printing unit; an acceptance unit configured to accept a first operation of giving an instruction to cut the continuous medium; and a notification unit, wherein during a period from when the acceptance unit accepts the first operation to when the cutting operation is executed, the notification unit notifies a remaining time, which is a time from when the acceptance unit accepts the first operation to when the cutting operation is executed, and the cutting unit executes the cutting operation after the remaining time elapses.

### BRIEF DESCRIPTION OF THE DRAWINGS

FIG. 1 illustrates the configuration of a printing device.

FIG. 2 shows the configuration of a control system of the printing device.

FIG. 3 shows an example of a first guide screen.

FIG. 4 shows an example of a second guide screen.

FIG. 5 shows an example of a third guide screen.

FIG. 6 is a flowchart showing an example of the operation of the printing device.

### DESCRIPTION OF EMBODIMENTS

### 1. Configuration of Printing Device

Hereinafter, the configuration of a printing device 1 according to an embodiment will be described with reference to the drawings.

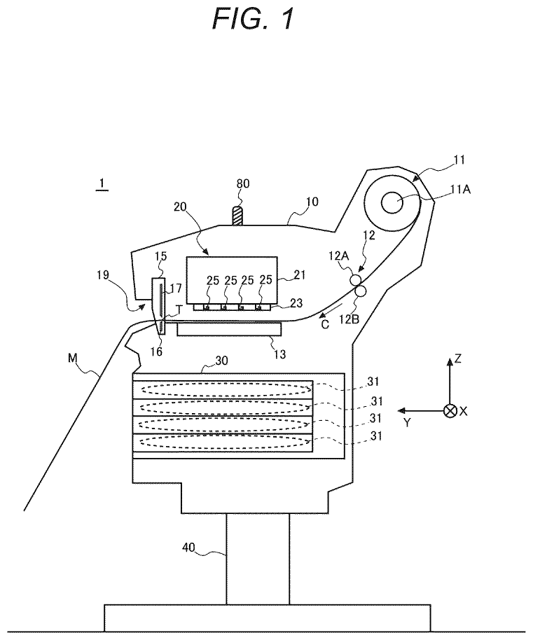

FIG. 1 is a diagram illustrating the configuration of the printing device 1. An X axis, a Y axis, and a Z axis illustrated in FIG. 1 are three axes orthogonal to each other, and a Z-axis direction indicates a vertical direction. The X axis and the Y axis represent directions parallel to a horizontal direction, the X axis indicates a left-right direction, and the Y axis indicates a front-back direction.

The printing device 1 ejects ink onto a continuous print medium M and thus prints an image such as a character or a photograph on the print medium M. The printing device 1 includes a support stand 40 and a housing 10 supported by the support stand 40.

The housing 10 includes a medium holding unit 11, a roller pair 12 made up of a driven roller 12A and a conveyance roller 12B, a printing unit 20, a platen 13, a cutter unit 15, and an ink storage unit 30. Also, the housing 10 is provided with a conveyance drive unit 50, a communication interface 60, a touch panel 70, and a control unit 100, which are not illustrated in FIG. 1, and an indication lamp 80 is provided at an upper part of the housing 10.

The medium holding unit 11 includes a feeding shaft 11A. A long print medium M is wound in the form of a roll around the feeding shaft 11A. The medium holding unit 11 holds the print medium M wound around the feeding shaft 11A.

The driven roller 12A and the conveyance roller 12B convey the print medium M fed from the medium holding unit 11 in a conveyance direction C illustrated in FIG. 1, and convey the print medium M to a printing position. The printing position is a position where a print head 23 provided in the printing unit 20 prints an image on the print medium M supported by the platen 13.

The printing unit 20 includes a carriage 21 configured to be movable in a main scanning direction X and the print head 23 disposed at the carriage 21. The print head 23 includes a plurality of nozzles 25 and performs printing on the print medium M. As illustrated in FIG. 1, the print head 23 is disposed at a lower part of the carriage 21 and faces the print medium conveyed to the printing position. The print head 23 may be, for example, an inkjet print head. In this case, the print head 23 performs printing on the print medium M by ejecting ink droplets onto the print medium M.

The platen 13 is disposed to face the printing unit 20 and functions as a support unit that supports the print medium M conveyed to the printing position.

The ink storage unit 30 includes a plurality of holding trays 31 that hold ink. The printing device 1 includes a pump unit, not illustrated, and the pump unit supplies the ink held in the holding tray 31 to the printing unit 20.

The print medium M on which the image is formed by the printing unit 20 is conveyed downstream in the conveyance direction C and is conveyed to a cutting position T. The cutting position T is a position where the continuous print medium M is cut by the cutter unit 15.

The cutter unit 15 corresponds to a cutting unit that executes a cutting operation. The cutting operation is an operation of cutting the print medium M after the printing unit 20 executes printing. The cutter unit 15 includes a fixed blade 16 and a movable blade 17, and the movable blade 17 is coupled via a gear or the like to a drive device such as a motor that drives the movable blade 17. In the cutter unit 15, when the motor is driven, the movable blade 17 moves toward the fixed blade 16 and cuts the print medium M conveyed to the cutting position T. In the printing device 1, the print medium M printed by the printing unit 20 is cut to a predetermined length by the cutter unit 15 and is discharged from a paper discharge port 19. However, the configuration of the cutter unit 15 is not limited thereto. As another example of the cutter unit, a cutter carriage which is equipped with a blade and is movable in the X-axis direction may be provided. In this example, as the cutter carriage is moved in the X-axis direction while the blade is brought into contact with the print medium M, the printed print medium M can be cut to a predetermined length. The cutter unit 15 is also simply referred to as a cutter.

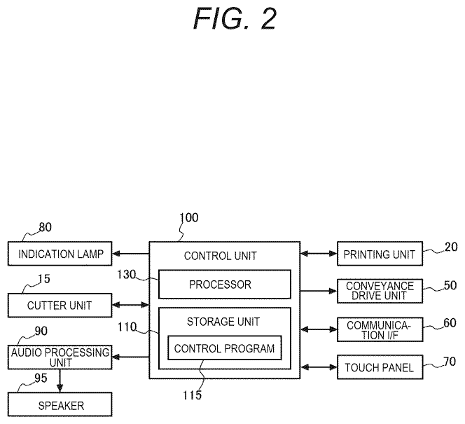

FIG. 2 is a diagram illustrating the configuration of the control system of the printing device 1.

The control unit 100 of the printing device 1 illustrated in FIG. 2 is coupled to the printing unit 20, the conveyance drive unit 50, the communication interface 60, the touch panel 70, the indication lamp 80, the cutter unit 15, and an audio processing unit 90. A speaker 95 is coupled to the audio processing unit 90. Hereinafter, the interface is abbreviated as I/F.

The conveyance drive unit 50 includes a drive source such as a motor, and causes the drive source to operate under the control of the control unit 100 and thus rotationally drives the conveyance roller 12B. Thus, the print medium M is conveyed in the conveyance direction C and sent to the printing position.

The communication I/F 60 includes, for example, a communication card such as a network interface card (NIC), and performs data communication with a control device such as a personal computer via a network, not illustrated.

The touch panel 70 corresponds to a display unit and an acceptance unit, or a display unit, an acceptance unit, and a notification unit. The touch panel 70 includes a display panel such as a liquid crystal panel or an organic EL (electro-luminescence) panel, that is, a display, and a touch sensor superimposed on or integrated with the display panel. Various images are displayed on the display panel under the control of the control unit 100. The touch sensor detects a touch operation on the display panel and outputs information indicating the position on the display panel where the touch operation is detected, to the control unit 100. The control unit 100 executes processing corresponding to the touch operation, based on the information input from the touch sensor.

The indication lamp 80 corresponds to a notification unit. The indication lamp 80 includes a light-emitting diode (LED) and emits an alarm by light. The indication lamp 80 can be configured with, for example, a PATLITE signal beacon. PATLITE is a registered trademark.

The audio processing unit 90 and the speaker 95 correspond to a notification unit. The audio processing unit 90 is configured with, for example, a processor for audio processing. The speaker 95 is coupled to the audio processing unit 90. The audio processing unit 90 D/A-converts audio data input from the control unit 100 into an analog audio signal. The audio processing unit 90 amplifies the converted audio signal and outputs the amplified audio signal from the speaker 95 as a sound. Although an example in which the three units of the touch panel 70, the indication lamp 80, and the audio processing unit 90 are provided as the notification unit is described, it is not essential to provide these three units, and at least one unit may be provided.

The control unit 100 is a computer including a storage unit 110 and a processor 130.

The storage unit 110 includes a RAM (random-access memory) and a ROM (read-only memory). The RAM is used to temporarily store various data, and the ROM stores a control program 115 for controlling the operation of the processor 130 and various setting information.

The processor 130 is an arithmetic processing device including a CPU (central processing unit) or an MPU (micro-processing unit). The processor 130 may be configured with a single processor or may be configured with a plurality of processors. The processor 130 may be configured with a SoC integrated with a part or all of the storage unit 110 or other circuits. The processor 130 may be configured with a combination of a CPU that executes a program and a digital signal processor executes (DSP) that predetermined arithmetic processing. Moreover, all functions of the processor 130 may be implemented in hardware, or a programmable device may be used. Various control functions realized by the processor 130 executing the control program 115 stored in the storage unit 110 may be simply described as an operation of the control unit 100 or an operation of the processor 130.

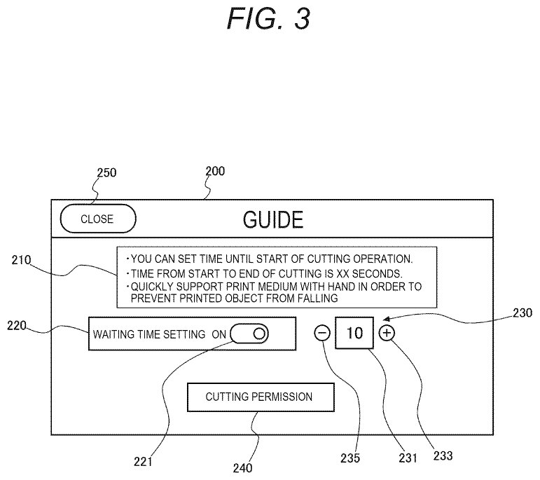

FIG. 3 is a diagram illustrating an example of a first guide screen 200. The first guide screen 200 corresponds to an operation screen.

Upon receiving print data from the control device, the control unit 100 determines the degree of dryness of the ink in the print processing executed based on the received print data. That is, the control unit 100 functions as a determination unit. A low degree of dryness of the ink means a state where the ink is relatively not dried, and when the print medium M on which the image is printed comes into contact with a floor surface or another object immediately after printing, the ink adheres to the floor surface or another object which the print medium M comes into contact with. Meanwhile, a high degree of dryness of the ink means a state where the ink is relatively dried, and when the print medium M on which the image is printed comes into contact with a floor surface or another object immediately after printing, the ink does not adhere to the floor surface or another object which the print medium M comes into contact with.

The control unit 100 determines the degree of dryness, based on the type of the print medium M used in the print processing. The print medium M is set, for example, by a printer driver installed in the control device or by a touch operation on the touch panel 70. For example, the control unit 100 determines that the degree of dryness is low, when the type of the print medium M is a medium that is non-absorbent and into which ink is unlikely to permeate. Examples of the type of the print medium M include a film for direct to film (DTF) on which an ink receiving layer is formed.

The control unit 100 may determine the degree of dryness of the ink, based on the printing duty. The printing duty indicates the ratio of the area or the amount of ink of an image printed per unit area when the image is printed on the print medium M. That is, the printing duty is the ratio of the area occupied by a region where ink is applied per unit area or the amount of ink applied per unit area. The control unit 100 calculates the printing duty, based on the print data.

The control unit 100 may also determine the degree of dryness after executing the print processing. The control unit 100 counts the amount of discharge of the ink discharged from the print head 23, and determines the degree of dryness of the image printed on the print medium M, based on the counting result.

The control unit 100 may also determine the degree of dryness of the ink in the print processing executed by the printing unit 20, based on the type of the ink used in the print processing. For example, if the ink applied to the print medium M is of a type that is assumed to be transferred to another medium, it is determined that the degree of dryness is low.

When it is determined that the degree of dryness of the image printed on the print medium M is low, or when the printing device 1 executes only printing with a low degree of dryness, the control unit 100 displays the first guide screen 200 illustrated in FIG. 3 on the touch panel 70 after executing the print processing.

The first guide screen 200 includes a first guidance display section 210, a switching display section 220, a waiting time setting section 230, and a cutting permission button 240.

Guidance information is displayed in the form of text in the first guidance display section 210. The first guidance display section 210 shown in FIG. 3 displays the three pieces of guidance information described below.

The first guidance information includes guidance indicating that the waiting time until the cutter unit 15 starts the cutting operation can be set by operating the first guide screen 200. The waiting time is a time from when the user presses the cutting permission button 240 to when the control unit 100 outputs a cutting instruction to the cutter unit 15. Upon accepting the cutting instruction, the cutter unit 15 immediately executes the cutting operation. Therefore, the output of the cutting instruction from the control unit 100 to the cutter unit 15 and the execution of the cutting operation by the cutter unit 15 are substantially synonymous except for a lag generated for a reason related to the control.

The second guidance information includes a display that shows the time required from when the cutter unit 15 starts the cutting operation to when the cutting of the print medium M ends.

The third guidance information includes a display that guides the user to quickly place a hand on and support the print medium M to be cut. The third guidance information corresponds to information for guiding the support of the print medium M printed by the printing unit 20.

The switching display section 220 accepts an operation of enabling or disabling the waiting time until the cutter unit 15 starts the cutting operation. A toggle button 221 for enabling or disabling the setting of the waiting time is displayed in the switching display section 220. Turning on the toggle button 221 enables the waiting time, and turning off the toggle button 221 disables the waiting time. When the cutting permission button 240 is pressed in a state where the toggle button 221 is turned off, the cutter unit 15 immediately starts the cutting operation. That is, hardly any waiting time is provided except for a lag generated for a reason related to the control.

The waiting time setting section 230 is a display that is enabled when the toggle button 221 of the switching display section 220 is turned on. In the waiting time setting section 230, a waiting time indication 231, a plus button 233, and a minus button 235 are displayed.

The waiting time indication 231 shows the current setting of the waiting time until the cutter unit 15 starts the cutting operation after the cutting permission button 240 is pressed.

The plus button 233 is a button for accepting an operation of adding a predetermined time to the waiting time shown in the waiting time indication 231 and thus increasing the waiting time.

The minus button 235 is a button for accepting an operation of subtracting a predetermined time from the waiting time shown in the waiting time indication 231 and thus shortening the waiting time.

The operation of the plus button 233 and the minus button 235 corresponds to a second operation of setting a time from when the operation of the cutting permission button 240 is accepted to when the control unit 100 outputs a cutting instruction, that is, until the cutting operation is executed.

The cutting permission button 240 is a button for permitting the execution of the cutting operation by the cutter unit 15. The operation of the cutting permission button 240 corresponds to a first operation. That is, when the user presses the cutting permission button 240, the control unit 100 determines that the first operation of giving an instruction to cut the print medium M is accepted.

The user operates the toggle button 221 displayed in the switching display section 220 and thus enables or disables the waiting time until the cutter unit 15 starts the cutting operation.

When enabling the waiting time, the user operates the plus button 233 or the minus button 235 to change the waiting time shown in the waiting time indication 231 to the waiting time desired by the user. Subsequently, the user presses the cutting permission button 240.

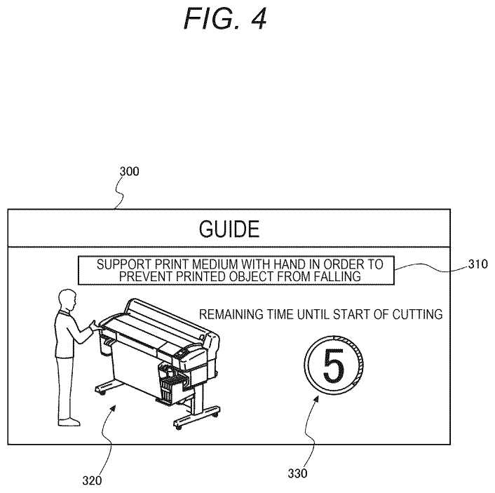

FIG. 4 is a diagram illustrating an example of a second guide screen 300 displayed when the cutting permission button 240 is pressed.

Upon accepting the pressing operation of the cutting permission button 240, the control unit 100 displays the second guide screen 300 illustrated in FIG. 4. The second guide screen 300 is displayed on the touch panel 70 after the operation of the cutting permission button 240 is accepted and before the control unit 100 outputs the cutting instruction. The second guide screen 300 is a screen for notifying the user of the remaining time until the control unit 100 outputs the cutting instruction to the cutter unit 15, that is, the time until the cutting operation is executed, and the second guide screen 300 includes a second guidance display section 310, an image display section 320, and a remaining time display section 330.

Guidance information is displayed in the form of text in the second guidance display section 310. Specifically, similarly to the first guide screen 200, a display for guiding the user to quickly place a hand on the print medium M to be cut by the cutter unit 15 and support the print medium M is provided. The guidance information displayed in the second guidance display section 310 corresponds to information for guiding the support of the print medium M printed by the printing unit 20.

The image display section 320 displays an image for guiding the user to quickly place a hand on the print medium M to be cut by the cutter unit 15 and support the print medium M. The image displayed in the image display section 320 corresponds to information for guiding the support of the print medium M printed by the printing unit 20.

The remaining time display section 330 displays the remaining time until the cutter unit 15 starts the cutting operation. In the example shown in FIG. 4, this remaining time is 5 seconds. The remaining time is updated every second and is counted down. Since the remaining time may be displayed in a mode that enables the user to roughly grasp the remaining time, a margin of error of several seconds may be acceptable. Factors that may lead to an error include a lag generated for a reason related to the control, a time required for the movable blade 17 to come into contact with the print medium M after the driving device such as a motor provided in the cutter unit 15 starts driving, and the like. For the same reason, the remaining time may not be displayed as a numerical value. For example, the color of a bar-like shape may be changed according to the remaining time, like a progress bar, so as to display the remaining time. In the example shown in FIG. 4, in addition to the numerical value of time (5 seconds), the remaining time is also indicated by a change in the color of a circular shape surrounding the numerical value.

The control unit 100 may display a cancel button, not illustrated, at the same time as the display of the second guide screen 300 on the display unit. The cancel button is provided to cancel the cutting operation when an unexpected situation occurs during the execution of the countdown. When the user presses the cancel button, the first guide screen 200 is displayed again on the touch panel 70.

When the remaining time becomes equal to or less than a preset time during the display of the second guide screen 300, the control unit 100 may turn on the indication lamp 80 or may cause the indication lamp 80 to flash on and off so as to notify the user that the remaining time until the start of the cutting is short. In this case, the indication lamp 80 functions as a notification unit.

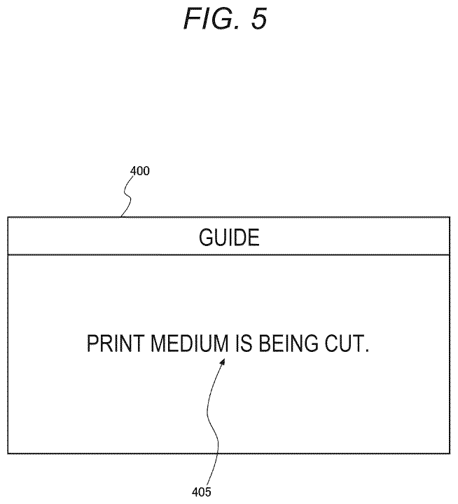

FIG. 5 is a diagram illustrating an example of a third guide screen 400.

When the remaining time displayed in the remaining time display section 330 runs out, the control unit 100 permits the cutter unit 15 to execute the cutting operation. The control unit 100 causes the touch panel 70 to display the third guide screen 400 illustrated in FIG. 5 and thus to indicate that the cutting operation is being executed.

On the print medium M on which an image is formed and which is cut by the cutter unit 15, subsequently, binder powder, which is powder of a hot-melt resin, is attached to the ink layer forming the image and is pressure-bonded by a heat press machine, thus transferring the image to a fabric made of natural fibers, synthetic fibers, or the like. When the ink is not dried, the binder powder can be easily attached thereto, and therefore it is necessary to execute the cutting operation in the state where the ink is not dried.

In the above description, the case where the control unit 100 notifies, via the touch panel 70, the remaining time until outputting the cutting instruction to the cutter unit 15 is described, but the speaker 95 may function as the notification unit. That is, the control unit 100 may output, from the speaker 95, a voice for guiding the user to quickly place a hand on the print medium M to be cut by the cutter unit 15 and support the print medium M. When the width of the print medium M in the X-axis direction is relatively large, it may be difficult for the user to recognize the display on the touch panel 70 since the touch panel 70 is disposed at a position away from the center of the printing device 1 in the X-axis direction. In such a case, the effect of the voice guidance is remarkable.

### 2. Operation of Printing Device

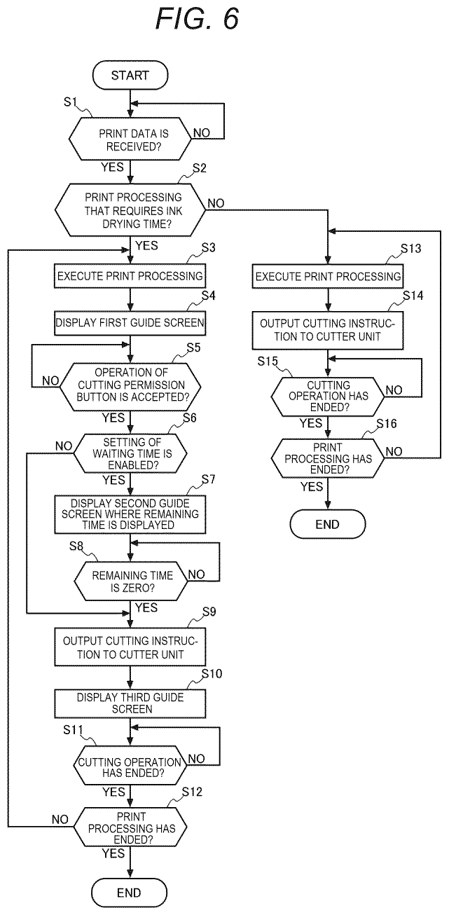

FIG. 6 is a flowchart showing the operation of the printing device 1.

The operation of the printing device 1 executed under the control of the control unit 100 will be described with reference to FIG. 6.

First, the control unit 100 determines whether print data is received from the control device such as a personal computer (step S1). When print data is not received (NO in step S1), the control unit 100 waits until print data is received.

When print data is received (YES in step S1), the control unit 100 determines whether the print processing to be performed subsequently is print processing that takes time to have a certain degree of dryness of the ink, that is, print processing that takes time until the ink is dried (step S2). For example, the control unit 100 determines the degree of dryness of the ink, based on at least one of information designating the type of the print medium M included in the print data, information of the print setting included in the print data, and the printing duty. The information of the print setting is, for example, whether a mode for attaching the binder powder, that is, a mode in which the print medium M is discharged in the state where the ink is not sufficiently dried, is designated, or a normal mode for not attaching the binder powder, that is, a mode in which the print medium M is discharged in the state where the ink is dried, is designated as the printing mode of the printing device 1.

When the degree of dryness of the ink is low in the print processing (YES in step S2), the control unit 100 causes the printing unit 20 to execute the print processing (step S3) and causes the touch panel 70 to display the first guide screen 200 (step S4).

Next, the control unit 100 determines whether an operation of the cutting permission button 240 is accepted (step S5). When an operation of the cutting permission button 240 is not accepted (NO in step S5), the control unit 100 waits until an operation of the cutting permission button 240 is accepted.

Upon accepting an operation of the cutting permission button 240 (YES in step S5), the control unit 100 determines whether the setting of the waiting time is enabled (step S6). The control unit 100 determines whether the toggle button 221 is on, and thus determines whether the setting of the waiting time is enabled.

When it is determined that the toggle button 221 is off and the setting of the waiting time is disabled (NO in step S6), the control unit 100 outputs a cutting instruction to the cutter unit 15 (step S9).

When the control unit 100 determines that the toggle button 221 is on and the setting of the waiting time is enabled (YES in step S6), the control unit 100 causes the touch panel 70 to display the second guide screen 300 on which the remaining time until the start of the cutting operation is displayed (step S7).

Next, the control unit 100 determines whether the remaining time until the start of the cutting operation is zero (step S8). When the remaining time is not zero (NO in step S8), the control unit 100 waits until the remaining time becomes zero. When the remaining time is zero (YES in step S8), the control unit 100 outputs a cutting instruction to the cutter unit 15. That is, the cutting operation is executed (step S9).

Upon outputting the cutting instruction to the cutter unit 15 (step S9), the control unit 100 causes the touch panel 70 to display the third guide screen 400 (step S10).

Next, the control unit 100 determines whether the cutting operation of the cutter unit 15 is finished (step S11). For example, the control unit 100 determines whether the cutting operation of the cutter unit 15 has ended, based on a signal which the cutter unit 15 outputs after the end of the cutting operation.

When the cutting operation of the cutter unit 15 has not ended (NO in step S11), the control unit 100 waits until the cutting operation ends. When the cutting operation of the cutter unit 15 has ended (YES in step S11), the control unit 100 determines whether all the print processing based on the print data received in step S1 has ended (step S12).

When all the print processing based on the print data has not ended (NO in step S12), the control unit 100 causes the printing unit 20 to execute the print processing again (step S3). When all the printing based on the print data has ended (YES in step S12), the control unit 100 ends the processing flow.

When it is determined in step S2 that the degree of dryness of the ink is high (NO in step S2), the control unit 100 causes the printing unit 20 to execute the print processing (step S13), and outputs a cutting instruction to the cutter unit 15 after the print processing is completed. That is, the cutting operation is executed (step S14).

Next, the control unit 100 determines whether the cutting operation of the cutter unit 15 has ended (step S15). When the cutting operation of the cutter unit 15 has not ended (NO in step S15), the control unit 100 waits until the cutting operation ends.

When the cutting operation of the cutter unit 15 has ended (YES in step S15), the control unit 100 determines whether all the print processing based on the print data received in step S1 has ended (step S16).

When all the print processing based on the print data has not ended (NO in step S16), the control unit 100 causes the printing unit 20 to execute the print processing again (step S13). When all the printing based on the print data has ended (YES in step S16), the control unit 100 ends the processing flow.

### 3. Summary of Present Disclosure

A summary of the present disclosure is appended below.

### Appendix 1

A printing device includes: a printing unit configured to print an image based on print data, on a continuous medium; a cutting unit configured to execute a cutting operation, which is an operation of cutting the continuous medium on which the image is printed by the printing unit; an acceptance unit configured to accept a first operation of giving an instruction to cut the continuous medium; and a notification unit, wherein during a period from when the acceptance unit accepts the first operation to when the cutting operation is executed, the notification unit notifies a remaining time, which is a time from when the acceptance unit accepts the first operation to when the cutting operation is executed, and the cutting unit executes the cutting operation after the remaining time elapses.

With this configuration, when the first operation is accepted, the notification unit notifies the remaining time until the cutting instruction is output to the cutting unit. Therefore, the user can recognize the remaining time until the continuous medium is cut. Thus, the continuous medium on which the image is printed and which is cut by the cutting unit can be prevented from falling onto the floor surface or the like. For example, when the degree of dryness of the image printed on the continuous medium is low, the user supports the cut continuous medium with a hand and thus can prevent the floor surface from being stained with the ink.

### Appendix 2

In the printing device according to Appendix 1, the notification unit notifies information for guiding support of the continuous medium printed by the printing unit during a period from when the first operation is accepted to when the cutting operation is executed.

With this configuration, the notification unit notifies the information for guiding the support of the continuous medium. Therefore, the user can be prompted to support the continuous medium.

### Appendix 3

In the printing device according to Appendix 1 or 2, the notification unit includes an audio output unit.

With this configuration, the remaining time until the cutting instruction is output to the cutting unit and the information for guiding the support of the continuous medium are notified by voice. Therefore, the user can be prompted to support the continuous medium.

### Appendix 4

In the printing device according to any one of Appendices 1 to 3, the notification unit includes a display unit.

With this configuration, the remaining time until the cutting instruction is output to the cutting unit and the information for guiding the support of the continuous medium are displayed on the display unit. Therefore, the user can be prompted to support the continuous medium.

### Appendix 5

In the printing device according to any one of Appendices 1 to 4, the notification unit includes an indication lamp that outputs an alarm by light, and the indication lamp turns on or flashes on and off when the remaining time is equal to or less than a predetermined time.

With this configuration, when the remaining time is equal to or less than the predetermined time, the indication lamp is turned on or is made to flash on and off. Therefore, the user can be prompted to support the continuous medium.

### Appendix 6

The printing device according to any one of Appendices 1 to 5, further includes a display unit, and the display unit displays an operation screen for accepting a second operation of setting the remaining time and the first operation, and the cutting unit executes the cutting operation after the remaining time elapses after the first operation is accepted on the operation screen.

With this configuration, the operation screen on which the first operation and the second operation are displayed is displayed, and an operation can be carried out on the operation screen so as to give an instruction to cut the continuous medium or set the time until the cutting instruction is output.

### Appendix 7

The printing device according to any one of Appendices 1 to 6, further includes a determination unit, and the determination unit determines a degree of dryness of an image printed on the continuous medium, based on the print data, and when the determination unit determines that the degree of dryness is low, the notification unit notifies the remaining time and the cutting unit executes the cutting operation after the remaining time elapses, and when the determination unit determines that the degree of dryness is high and when the first operation is accepted, the cutting unit executes the cutting operation after a lapse of a time shorter than the remaining time of when the determination unit determines that the degree of dryness is low.

With this configuration, when the degree of dryness of the image printed on the continuous medium is low, the continuous medium is cut after waiting for the cutting of the continuous medium, and when the degree of dryness of the image printed on the continuous medium is high, the continuous medium is cut after the end of the printing without waiting for the cutting of the continuous medium. Therefore, the operation of the printing device can be appropriately changed. Also, unnecessary screen displays and the waiting time of when the degree of dryness is high can be reduced.

What is claimed is:

1. A printing device comprising:
a printing unit configured to print an image based on print data, on a continuous medium;
a cutting unit configured to execute a cutting operation, which is an operation of cutting the continuous medium on which the image is printed by the printing unit;
an acceptance unit configured to accept a first operation of giving an instruction to cut the continuous medium; and
a notification unit, wherein
during a period from when the acceptance unit accepts the first operation to when the cutting operation is executed, the notification unit notifies a remaining time, which is a time from when the acceptance unit accepts the first operation to when the cutting operation is executed, and
the cutting unit executes the cutting operation after the remaining time elapses.

2. The printing device according to claim 1, wherein
the notification unit notifies information for guiding support of the continuous medium printed by the printing unit during a period from when the first operation is accepted to when the cutting operation is executed.

3. The printing device according to claim 1, wherein
the notification unit includes an audio output unit.

4. The printing device according to claim 1, wherein
the notification unit includes a display unit.

5. The printing device according to claim 1, wherein
the notification unit includes an indication lamp that outputs an alarm by light, and
the indication lamp turns on or flashes on and off when the remaining time is equal to or less than a predetermined time.

6. The printing device according to claim 1, further comprising:
a display unit, wherein
the display unit displays an operation screen for accepting a second operation of setting the remaining time and the first operation, and
the cutting unit executes the cutting operation after the remaining time elapses after the first operation is accepted on the operation screen.

7. The printing device according to claim 1, further comprising:
a determination unit, wherein
the determination unit determines a degree of dryness of an image printed on the continuous medium, based on the print data,
when the determination unit determines that the degree of dryness is low,
the notification unit notifies the remaining time, and
the cutting unit executes the cutting operation after the remaining time elapses, and
when the determination unit determines that the degree of dryness is high, when the first operation is accepted, the cutting unit executes the cutting operation after a lapse of a time shorter than the remaining time of when the determination unit determines that the degree of dryness is low.
